(19) United States
(12) Patent Application Publication
(10) Pub. No.: US 2008/0065523 A1
(43) Pub. Date: Mar. 13, 2008

(54) eValuation: a system for conducting an online auction whereby a transparent algorithm converts collected site data into the valuation of a bid and the putative value of the item sold

(76) Inventor: Jonathan Mark Schneider, Durham, NC (US)

Correspondence Address: JONATHAN MARK SCHNEIDER, 2616 ERWIN RD., # 1723, DURHAM, NC, 27705, US

(21) Appl. No.: 11/517,632

(22) Filed: Sep. 8, 2006

(51) Int. Cl. G06Q 40/00

(52) U.S. Cl. 705/37

(57) ABSTRACT

A system for conducting an online auction using a transparent algorithm to convert collected site data into the valuation of a bid and the putative value of the item sold. Users will be able to participate in an online auction that discloses the comprehensible algorithm used to convert collected site data into the valuation of a bid.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to the field of Online Auctions, which is a sub-field of the field of e-Commerce.

The prior art has no function for conducting an online deterministic auction like the one set out in this application. Previous online auctions have been based on the traditional rules of auctions, usually allowing bidders to set their own bids—at nearly any level—in an effort to outbid one another. Participants' bids are at the level of their own choosing. While useful in the auctioning of many items, this method is limited in its ability to raise the value of an item and provides a lower level of interest for auction participants.

### SUMMARY OF THE INVENTION

The invention in this application allows for a new way of conducting an online auction. Under the new set of rules, a bidder places a bid at a monetary amount not of his own choosing but rather based upon the transparent algorithm then in use in the auction. Because the algorithm converts collected website data into the valuation of a bid, this invention allows for the re-valuation of an object of value. For example, the algorithm may convert high site traffic into high lot value. In this way, as an auction gains more interest, the value of the item increases as well. This type of auction could therefore be more useful than the prior art in the auctioning of certain items, such as artwork, which have a value based in part on their popularity and visibility. (The “value” of artwork is always subtle and subjective. This new method of conducting an online auction allows an item of subjective value to gain in value by demonstrating the popularity and visibility of the item.) This increase in value is a benefit to both buyer and seller.

### BRIEF DESCRIPTION OF THE SEVERAL VIEWS OF THE DRAWING

FIG. 1—FIG. 1 shows the first possible setup for the hardware and external processes of this new type of auction. This is the simplest such setup. In this setup, the host computer both manages and hosts the auction. End users connect through the internet to the host computer, which auctions the item of value. A peripheral device, such as a webcam, may be used, which in this setup would be connected to the host computer. The host computer would then broadcast the information over the internet to end users.

FIG. 2—FIG. 2 shows a slightly more complex setup for the hardware and external processes of this new type of auction. In this setup, the auctioneer's computer still manages the auction and retrieves the signal from an optional peripheral device (such as a webcam) but no longer hosts the auction. Instead, a remote server hosts the auction and communicates with end users. The auctioneer's computer simply transmits to the host server the information necessary for the management of the auction (for example, the start and stop time of the auction, the selection of the appropriate algorithm, and the optional inclusion of a video signal from a webcam).

FIG. 3—FIG. 3 shows a more complex setup for the hardware and external processes of this new type of auction. In this setup, the optional peripheral device (such as a webcam) does not communicate directly with the auctioneer's computer but rather with an independent server capable of coding video information for broadcast over the internet. End users would communicate with a remote server that would host the auction. This server would also direct the end users' computers to the server responsible for the video signal. Thus, end users would be getting their information from two separate servers, but the appearance of the website on their computers would be as one seamless and integrated website. In this setup, the auctioneer's computer would still manage the details of the auction by communicating with the remote server.

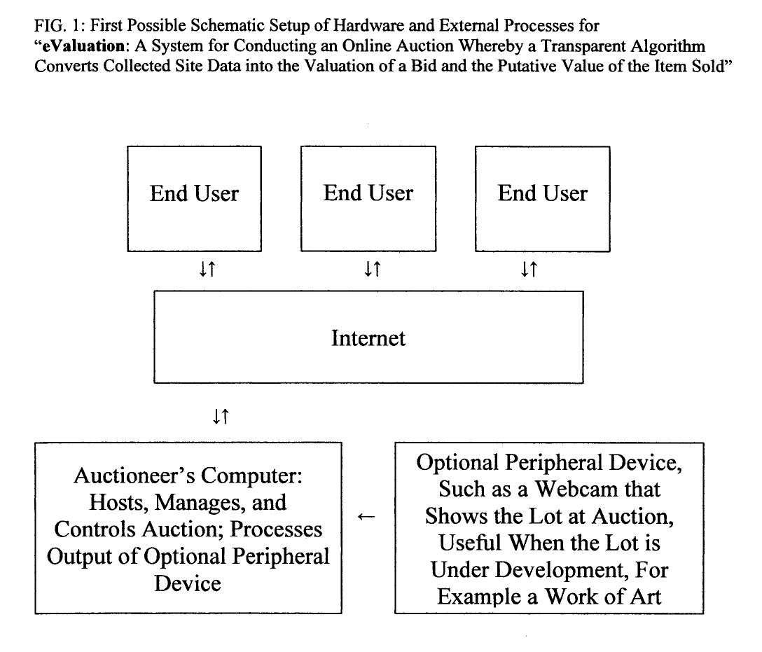

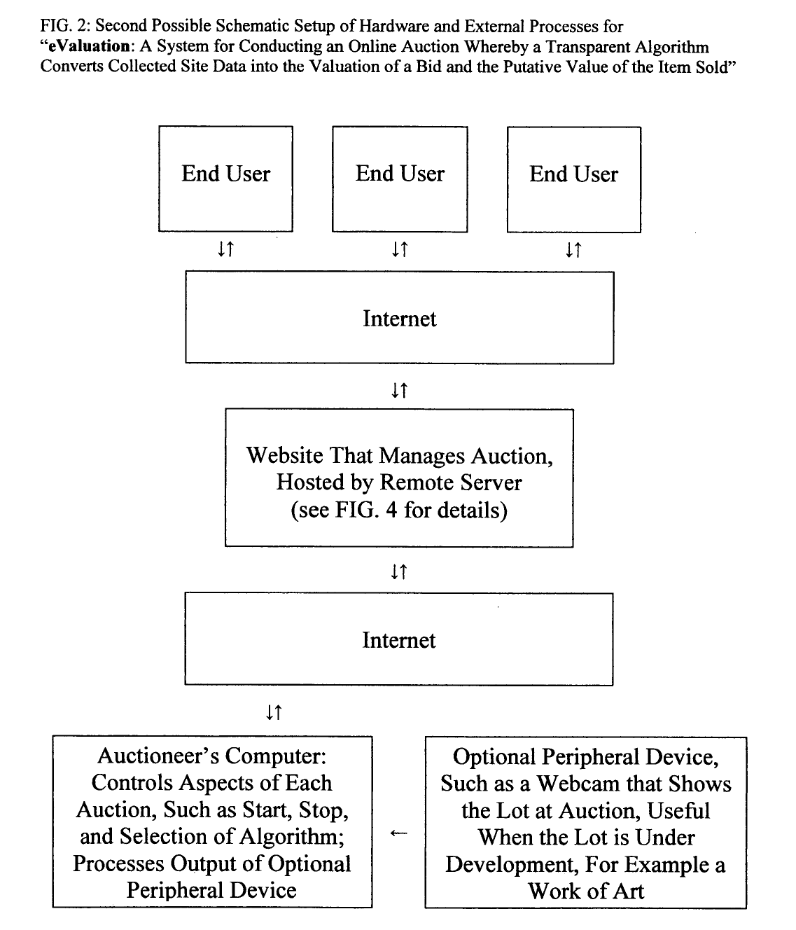

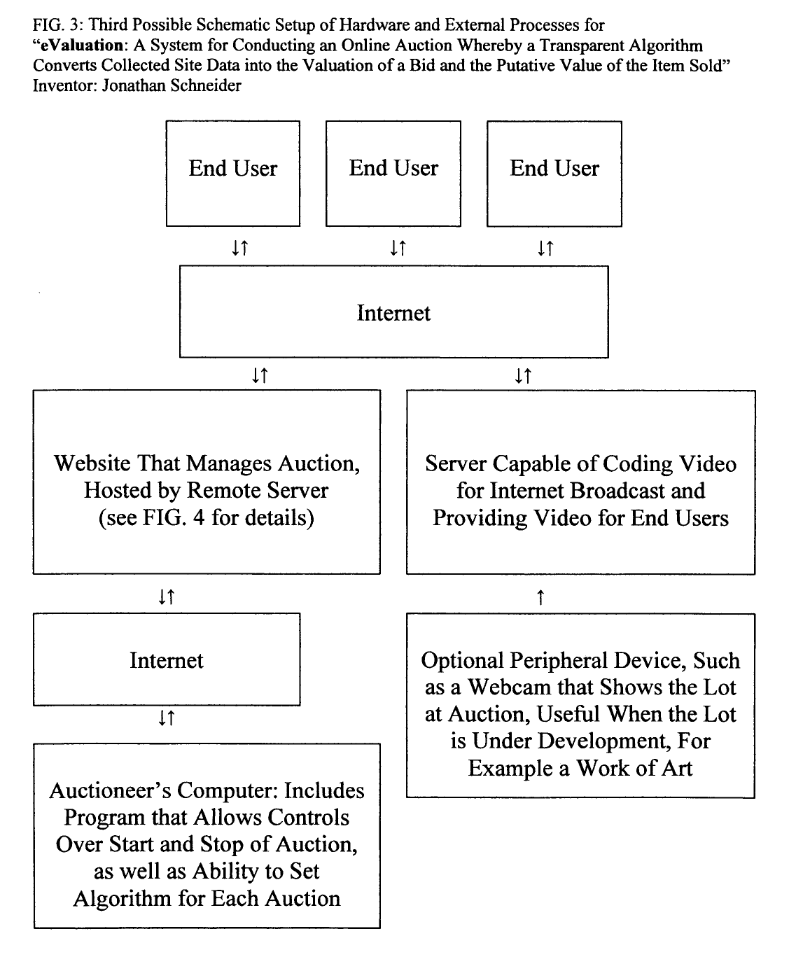

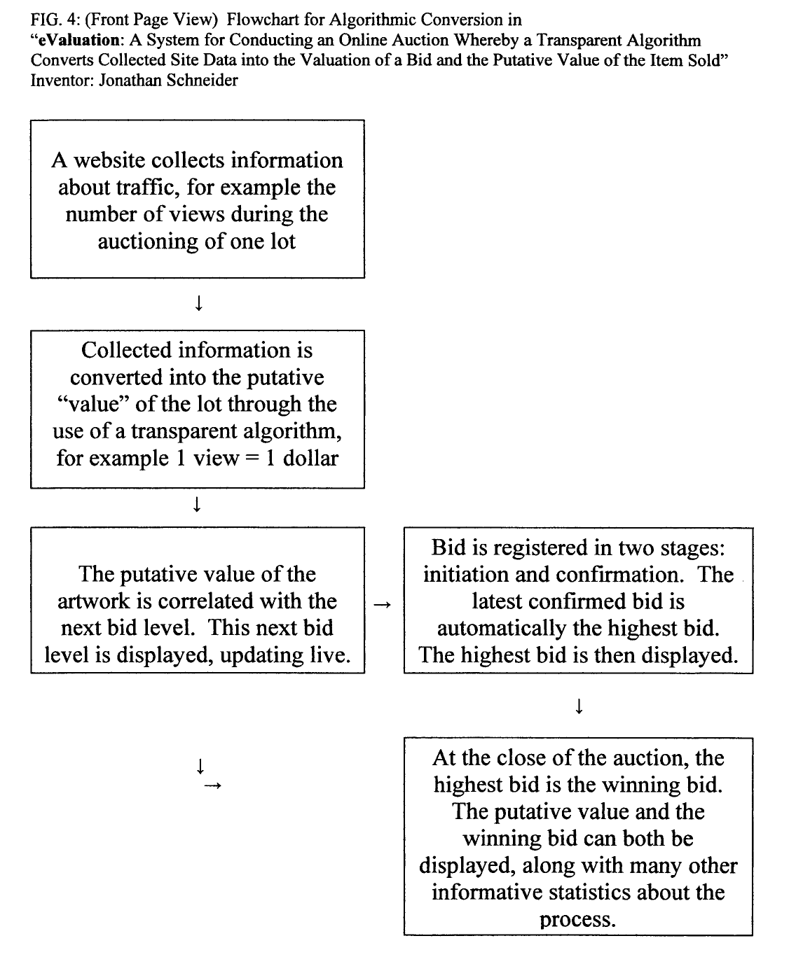

In FIGS. 1 through 3, three end users are shown, to represent in principle an unlimited number of potential end users. The number of end users would not be capped at three. Three end users are shown only for the purposes of clarity and simplification.

In FIGS. 1 through 3, only one server/computer/peripheral device is shown wherever such a device could be used. However, it shall be assumed that multiple individual units that effectively perform the same actions could also be used. For example, a webcam might communicate directly with not one but multiple servers, and these servers could all be used to broadcast the video to the end users over the internet, as a means of enhancing the quality and/or efficiency of the viewing experience for a greater number of end users.

FIG. 4—FIG. 4 presents the flowchart for the Algorithmic Conversion and internal logic of the website that will host the online auction. (FIG. 4 can serve as the Front Page View for the purposes of publication; however, it is listed fourth here because it illustrates internal processes.) As can be seen in this figure, information collected by the website is converted into the putative value of the item at auction, based on the specific, transparent algorithm then in use. This putative value then translates directly to the next bid amount, or the amount that an end user will have to bid in order to make a bid. When a bid is placed, the bidder will have the opportunity to review and accept or reject the bid. At the end of the auction, the highest bid recorded becomes the winning bid, and the winning bid and final valuation of the lot are displayed.

### DETAILED DESCRIPTION OF THE INVENTION

The concept called evaluation is a new form of auctioning items of value. This new form introduces an element of determinism into the auction process. The determinism is accomplished by an algorithmic approach to the valuation of auctioned items. The algorithms involve formulaic assignment of monetary auction bids, transparent (in the sense of disclosed and comprehensible) to the auction participants, in real time, and open to anyone having legal access to the Internet website for the auction. The particulars of the algorithms used for a specific auction are at the discretion of the auction host, as are the details of the timing for auctioning each item of interest. The key novelty of evaluation is the deterministic valuation of every bid during the course of the auction.

The following example implementation of evaluation clarifies the general description of the process. Suppose the auction is conducted by an artist for the duration of the creative process, the item of interest being the artwork created. The artist/auctioneer may choose to allow public access to the creative process, as, for example, via a webcam that broadcasts the process from start to finish. As the artwork being created/auctioned evolves, the bidding proceeds via the Web with the proviso that every bid initiated by any participant will have a valuation as determined by the current algorithm based on traffic data from the auction website. (When participants choose to initiate a bid, the website will calculate the exact valuation of the bid and give the bidder the opportunity to accept or reject the calculated bid before placing it.) A set of real-time counters will display the cumulative traffic data being used as the basis for conversion; and the formulaic conversion from counter data to bid valuation will be displayed simultaneously. The artist/auctioneer terminates every auction when he deems the artwork to be complete. The artwork is sold to the highest bidder that has been recorded, and the putative value of the artwork is the final bid valuation recorded at termination of the auction.

What is claimed is:

1- A new system for conducting an online auction, whereby a transparent (in the sense of disclosed and comprehensible) algorithm converts collected site data into the valuation of a bid and the putative value of the item sold.

2- The system of claim 1, wherein the specific algorithm used to convert site data into the valuation of a bid is chosen at the discretion of the auctioneer and can change from one auction to the next, so long as the algorithm to be used for each auction is transparent to all participants for the duration of the auction.

3- The system of claim 1, wherein the collected site data, used by the algorithm for the purpose of determining the valuation of a bid, can include any information fairly collected by the website that hosts the auction, for example: the amount of traffic on the individual auction page during the course of the auction, the amount of traffic on the entire website, the duration of an auction, the number of bids initiated, and any other fairly collected data.
